(19) United States
(12) Patent Application Publication
(10) Pub. No.: US 2020/0067864 A1
(43) Pub. Date: Feb. 27, 2020

(54) SYSTEM AND METHODS FOR INTEGRATING SOCIAL NETWORK INFORMATION

(71) Applicants: AARON RANKIN, Chicago, IL (US); JUSTYN HOWARD, Chicago, IL (US); SUNDEEP MALLADI, Chicago, IL (US)

(72) Inventors: AARON RANKIN, Chicago, IL (US); JUSTYN HOWARD, Chicago, IL (US); SUNDEEP MALLADI, Chicago, IL (US)

(73) Assignee: Sprout Social Inc., Chicago, IL (US)

(21) Appl. No.: 16/288,560

(22) Filed: Feb. 28, 2019

Related U.S. Application Data
(63) Continuation of application No. 14/696,264, filed on Apr. 24, 2015, now abandoned.
(60) Provisional application No. 61/983,828, filed on Apr. 24, 2014.

(51) Int. Cl. H04L 12/58; H04L 29/08; H04W 4/21

(52) U.S. Cl. CPC H04L 51/16; H04W 4/21; H04L 51/32; H04L 67/02

(57) ABSTRACT

A system for integrating social media information or other electronic interactions may comprise a database configured to store instances of interaction among a plurality of users, such as users of one or more electronic social media networks, and an application configured to be installed on the computer system of a first one of the plurality of users. The application may be configured to collect information from a website displayed in a web browser on the user's computer system, determine if the information includes a second one of the plurality of users, and display on the user's computer system one or more instances of interaction between the first user and the second user that are stored in the database. The application may be configured to operate with one or both of social media network websites and non-social-media network websites.

### CROSS-REFERENCE TO RELATED APPLICATION

This application is a continuation of U.S. non-provisional application Ser. No. 14/696,264, filed Apr. 24, 2015, which claims priority to U.S. provisional application No. 61/983,828, filed Apr. 24, 2014, now expired, which are hereby incorporated by reference in their entirety.

### BACKGROUND

### a. Technical Field

The instant disclosure relates to social media, including the integration of social media information into various contexts.

### b. Background Art

Numerous electronic social media services and networks are widely used for personal and/or business purposes. For example, some social media networks provide mass messaging capabilities (e.g., TWITTER), others provide the ability to post and view photographs (e.g., INSTAGRAM), while some are intended to provide broader services, such as personal information and interactions (e.g., FACEBOOK) and business information and interactions (e.g., LINKEDIN). A common thread between social media networks is the ability to share information among users. Users may read information posted by other users, provide information for specific users, provide information generally for the network or a subset of the network, etc. In the course of sharing information, users of a social media network frequently have interactions with specific other members of the network. Thus, a single individual may have a large number of interactions with numerous other users across a number of social media networks in a given time frame.

Although social media networks generally provide the ability to share information with other users of the same network, they generally do not easily integrate shared information with other social media networks or with non-social media. As a result, interactions between two users of a social media network are generally provided in a relative vacuum, without interactions between those same two users on another social media platform. Furthermore, even where different social media networks are linked, interactions between two users on a those networks are generally not provided outside the context of some social media platform.

### SUMMARY

A system for integrating social media information may comprise a database configured to store instances of electronic interaction among a plurality of users such as on one or more electronic social networks or through email and an application configured to be installed on the computer system of a first one of the plurality of users. The application may be configured to collect information from a website displayed in a web browser on the first user's computer system, determine if the information includes a second one of the plurality of users, and display on the first user's computer system one or more instances of interaction between the first user and the second user that are stored in the database. The application may be configured to operate with one or both of social media network websites and non-social-media-network websites.

A method for integrating social media information may comprise collecting information from a website interface displayed in a web browser of a first user's computer system and determining if the collected information includes identification of a second user of an electronic social network having one or more interactions on the electronic social network with the first user. The method may further comprise retrieving the one or more interactions from a database and displaying the one or more interactions over the website interface.

In an embodiment of the system or method, electronic interactions on an entity-to-entity basis, instead of or in addition to an individual-to-individual basis, may be stored in the database and displayed for a user. Accordingly, numerous users may be associated with a given entity, and numerous entities may be represented in the database. If a second user identified on a webpage of the first user's computer is associated with a larger entity, all electronic interactions between that entity and the first user may be retrieved from the database and displayed for the first user. Similarly, if the first user is associated with a larger entity, electronic interactions between the first user's entity and an identified second user (or the identified second user's entity) may be retrieved and displayed.

### BRIEF DESCRIPTION OF THE DRAWINGS

FIG. 1 is a block diagram view of an exemplary system for integrating social network information into a non-social-network context.

FIG. 2 illustrates a user login for an exemplary application for integrating social network information into a non-social-network context.

FIG. 3 illustrates a passive state of an exemplary application for integrating social network information into a non-social-network context.

FIG. 4 illustrates an active state of an exemplary application for integrating social network information into a non-social-network context.

FIG. 5 illustrates social media information provided by an exemplary application for integrating social network information into a non-social-network context.

FIG. 6 illustrates a first exemplary user interaction with the social media information of FIG. 5.

FIG. 7 illustrates a second exemplary user interaction with the social media information of FIG. 5.

### DETAILED DESCRIPTION

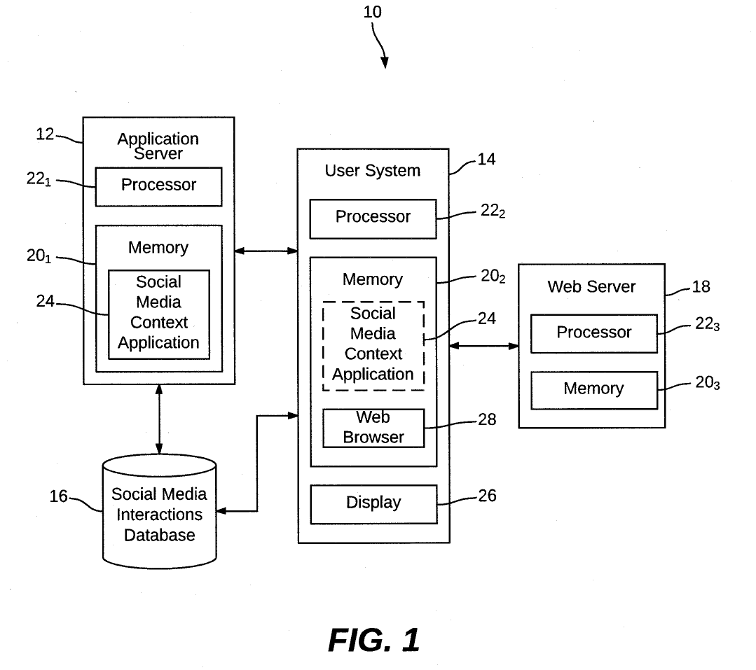

Referring to the figures, wherein like reference numerals refer to the same or similar features in the various views, FIG. 1 is a block diagram view of an exemplary system 10 for integrating social network information into various contexts including, but not limited to, a non-social-network context (e.g., a non-social-media website). The system 10 may include an application server 12, a user computer system 14, a social media interactions database 16, and a web server 18. The application server 12, the user system 14, and the web server 18 may each include a respective computer-readable memory 20₁, 20₂, 20₃ (which may be referred to generically as a memory 20) configured to store instructions and a respective processor 22₁, 22₂, 22₃ (which may be referred to generically as a processor 22) configured to execute the instructions stored in the associated memory 20₁, 20₂, 20₃. A first copy or version of a social media context application 24 (which may be referred to herein simply as “the application”) may be stored in the memory 20₁ associated with the application server 12, and a second copy or version of the social media context application 24 may be stored in the memory 20₂ associated with the user system 14. The user computer system 14 may additionally include a display 26 and a web browser 28.

Information that is “stored” in a computer-readable memory may be in any form. For example, the application 24 may be stored in a memory 20 in executable form, in the form of an installation file, in a non-executable form comprising the files and directories necessary to build an executable version of the application 24, or in some other form.

Each processor 22 and memory 20 may be of a suitable type and in a suitable configuration for the functionality described herein. Additionally or alternatively, any of the user computer system 14, application server 12, and web server 18 may include a programmable logic device (PLD), application-specific integrated circuit (ASIC), or other processing device. Each memory 20 may be or may include any non-volatile computer-readable memory, in an embodiment. Each associated processor 22 and memory 20 may be in communication with another processor 22 and memory 20 via any communication bus and/or other wired or wireless electronic communication means. In addition, the display 26 of the user's computer system 14 may be in communication with the processor 22 and/or memory 20 of the user computer system 14 over any communication bus and/or other wired or wireless electronic communication means.

The user computer system 14 may be or may include a personal computer or mobile device (e.g., tablet, smart phone), in an embodiment. However, the user computer system 14 is not limited to such embodiments. Rather, the user computer system 14 may be any computing system appropriate for performing the functionality described herein.

In an embodiment, the user computer system 14 may include the web browser 28 (e.g., a web browser 28 may be installed in the memory 20₂ of the user computer system 14). The user computer system 14 may be in electronic communication with the web server 18 (e.g., over the Internet). The web server 18 may provide one or more web pages that may be accessed by the user computer system 14 (e.g., via the web browser 28) and viewed on the display 26. Such web pages may include pages associated with one or more social media networks and pages not associated with a social media network. The web pages provided by the web server 18 may include information regarding one or more individuals, which individuals may be users of one or more social media networks. For example, a non-social-media web page provided by the web server 18 may include information about one or more individuals with whom a user of the user computer system 14 has had one or more interactions on one or more social networks.

The application server 12 may be configured to provide the social media context application 24 to the user computer system 14. For example, the application server 12 may provide a downloadable installation file including the social media context application 24 for the user computer system 14. Additionally or alternatively, the application server 12 may store the social media context application 24. For example, the application server 12 may provide the social media context application 24 on a software-as-a-service basis, and the application 24 may be accessed via a client on the user computer system 14, such as a client associated with the web browser 28.

The database 16 may be or may include one or more data repositories including, but not limited to, one or more databases and database types as well as data storage that may not necessarily be colloquially referred to as a “database.” The database 16 may store records of one or more electronic interactions between two or more individuals. For example, the database 16 may store records of interactions of two or more users of one or more social media networks. Additionally or alternatively, the database 16 may store records of interactions of two or more email account users (i.e., addresses) with each other. At least one of those users may be a user of the user system 14, in an embodiment. Additionally or alternatively, the database 16 may store records of electronic interactions of the user of the user system 14 with one or more other entities or individuals, over one or more social networks or otherwise. The database 16 may be operated by an operator of a social media network, for example, which operator may maintain records of interactions between users of the social media network that are stored in the database. The database 16 may additionally or alternatively be maintained by a third party or by a user of the user system 14.

In an embodiment, the database 16 may include a single database of interactions on multiple social media networks and/or other digital interactions. Such a database 16 may be maintained by an operator of a single one of those networks, or by a third party. Accordingly, in an embodiment, a single database 16 may be provided in the system that includes a plurality of interactions between a plurality of users on a plurality of social networks and that additionally includes a plurality of other electronic interactions by those users, such as email correspondence, for example. Still further, in an embodiment, the database 16 may be specific to (or may include a portion that is specific to) a user of the user system 14. The database 16 may store records of a plurality of electronic interactions between the user and other individuals or entities including, but not limited to, interactions on one or more social media networks.

As used in this disclosure, a “user” may refer to an individual or a larger entity. For example, a user may be an individual having numerous social media and email accounts, or an entity such as a business, trade association, government department, etc. having one or more official social media and email accounts. Numerous individuals may be associated with a larger entity, and the accounts of those individuals and of the entity itself may be associated with the entity. Accordingly, in an embodiment, the database 16 may associate the accounts of an individual with one or more larger entities with which the individual is associated. Of course, official accounts respective of an entity may also be associated with the entity in the database 16.

The database 16 may be populated by accessing a user's social media accounts, in an embodiment. For example, interactions from a given one of the user's social media accounts may be obtained by the application and stored in the database 16 by automatically polling the user's history in that social network when the user logs in to the social network. In an embodiment, such polling may be performed by the social media context application 24 when the user is logged in to the social media network through a browser 28 in which the application 24 is running.

Additionally or alternatively, the database 16 may be populated by accessing a user's other accounts (e.g., email accounts). For example, interactions from a given one of the user's email accounts may be obtained by the application and stored in the database 16 by automatically polling the user's sent, received, and drafted email in that email account when the user logs in to the email account. In an embodiment, such polling may be performed by the social media context application 24 when the user is logged in to the email account through a browser 28 in which the application 24 is running.

The user computer system 14 may access the database 16 through the user's secure access to a social network or other account (e.g., email account) with which the database 16 is associated, in an embodiment. Thus, the user computer system may access multiple databases 16 of social media interactions maintained by multiple different social network operators through the user's secure access to each of those social networks, in an embodiment. Alternatively, the database may be accessed via credentials provided by a third party that maintains the database.

The social media context application 24 may be generally configured, in an embodiment, to provide information about electronic interactions between a user and other individuals and entities on, for example, one or more social media networks, one or more email accounts, etc., in various contexts. For example, the social media context application 24 may be installed on the user computer system 14 and configured to retrieve information from the database 16 regarding electronic interactions between the user and other individuals and entities, such as on a social media network, and to provide that information outside the context of that social media network or other form of electronic interaction. Such electronic interactions may include communications, including exchanges of messages, may include relationships (i.e., that a first user and a second user are “friends,” “contacts,” etc., as those terms are generally used in the social media context), an/or may include some other form of intentional, affirmative interaction between two individuals or entities. This provision process may include, for example, transforming the information regarding electronic interactions stored in the database 16 into a user-readable list, menu, interface, etc.

Interactions may include interactions on multiple social networks or other accounts, for example, and may be retrieved from one or more databases 16. For example, the social media context application 24 may be configured to scan a web page provided by the web server 18 as it is accessed by the user computer system 14 (e.g., via the web browser 28), collect information from that web page, determine if the collected information includes information about a user of a social media network or other individual or entity with whom the user of the user system 14 has had interaction, retrieve the interactions from the database 16, and display the interactions. In an embodiment, the social media context application 24 may be configured to superimpose the interactions over the web browser interface.

As noted above, the database 16 may associate individuals with larger entities, in embodiments. Accordingly, when a user, individual, or entity with which the user of the user system 14 has had electronic interaction is identified, electronic interactions between the user of the user system 14 and the identified user, individual, or entity, and all other users, individuals, or entities associated with the identified user, individual, or entity may be retrieved and displayed. For example, if an individual is identified, and that individual is associated with Acme Corp., electronic interactions between the user of the user system 14 and the identified individual, Acme Corp., and/or one or more other users associated with Acme Corp may be retrieved and displayed. Similarly, if the user of the user system 14 is associated with Beta Corp., electronic interactions between users associated with Beta Corp. and users associated with Acme Corp. may be retrieved and displayed.

Information that is identified and collected by the social media context application 24 from a webpage may include, but is not limited to, names, email addresses, social network usernames, URLs, and the like. The social media context application may compare collected information with information stored in the database 16 to determine if an individual or entity, such as a user of a social media network, an email user, a company, etc., with whom the user of the user system 14 has had electronic interaction is represented on the webpage (i.e., to identify one or more users from the collected information with whom the user of the user system 14 has had interactions). As a result, the social media context application 24 may establish an indirect match between a webpage and the social media interactions of an individual or other entity represented on that webpage.

As a part of identifying information on a webpage, the social media context application 24 may assign a confidence rating to an item of information. That is, the social media context application may determine a confidence rating for whether an identified item of information is an email address, a name, a social media network username, etc. If the confidence rating is above a predetermined threshold, the social media context application may compare the identified information with information stored in the database 16.

In an embodiment, the social media context application 24 may be associated with the web browser 28 on the user computer system 14. For example, the social media context application 24 may be an extension, plug-in, or add-on to the browser 28. As noted above, the social media context application 24 may be configured to extract information from the browser interface and to superimpose information on the browser interface for display on the display 26 of the user computer system 14.

As noted above, a third party may maintain the database 16. In an embodiment, the database 16 may be maintained by a provider of the application 24. Thus, a third party may retrieve a user's interactions on one or more social media networks and store those interactions in the database 16. The retrieval may be performed by the application 24, in an embodiment. Furthermore, the same third party may provide the application 24 by, for example, offering the application 24 on a software-as-as-service basis, offering the application 24 for download by the user, or on some other basis.

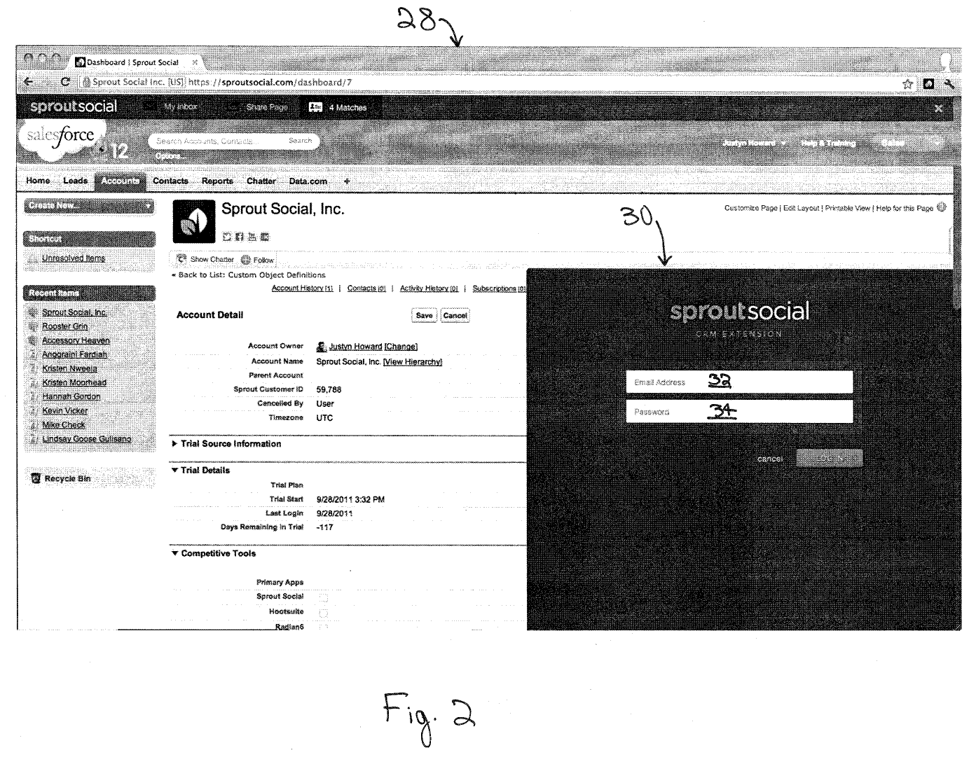

As generally described above, the social media context application 24 may interact with the social media interactions database 16 and the web server 18 to display records of social media interactions stored in the database 16 with a web page provided by the web server 18. FIGS. 2-7 generally illustrate an exemplary operation of the social media context application 24 in a web browser interface.

FIG. 2 illustrates a user login for an exemplary embodiment of the social media context application. The social media context application may accept user credentials (e.g., e-mail address 32 and password 34) through a login interface 30. The login interface 30, like other portions of the interface of the application 24, may be integrated into or superimposed over the interface of the web browser 28, in embodiments. The social media context application may associate a particular e-mail address or other identifier of a user (e.g., a user name) with one or more social media accounts, email accounts, or other accounts of the user. The social media account may additionally associated the identifier of the user with a larger entity, such as the user's employer, for example. Thus, in an embodiment, when a user logs in to the social media context application, the social media context application may automatically log the user in to the one or more associated social media networks and other accounts for access to a social media interactions database associated with each of those networks and accounts. Alternatively, as noted above, the user may be logged in only to the application, and the application may have direct access to the database.

Once the user enters login credentials 30, 32 for the social media context application, the social media context application may verify the user's login credentials. The verification may be performed locally (e.g., by a comparison of the login credentials entered by the user with a set of credentials stored on the user computer system) and/or remotely (e.g., by a comparison of the login credentials entered by the user with a set of credentials stored on a device or system in communication with the user computer system such as, for example only, the application server). During the login process, the social media context application may also perform additional configuration steps such as, for example only, logging the user in to one or more social media networks and other accounts associated with the user, opening a communications channel with one or more databases associated with those social networks and accounts, etc.

With a user logged in to the social media context application, the application may have an idle state and an active state, in an embodiment. In the idle state, the application may scan for individuals and other entities with which the user has had electronic interaction (such individuals may be referred to herein as “recognized individuals”). For example, the application may scan the content of a web page in the web browser 28 of the user's computer system. The application may scan the displayed content of the web page, the underlying code of the web page, and/or some other information associated with the web page. Additionally or alternatively, in the idle state, the application may determine whether such an individual or other entity is likely to be found. For example, the application may compare the domain of the web page with a list of domains that are recognized by the application.

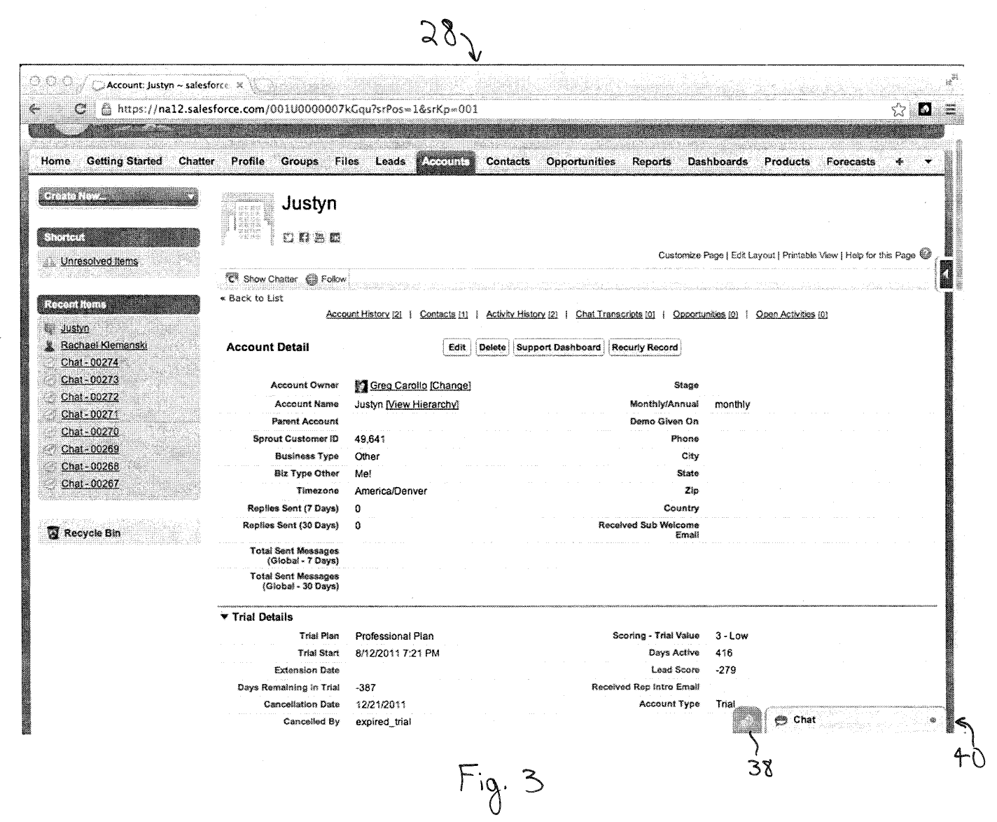

Referring to FIG. 3, the social media context application may display an indication of its state. In the idle state, the application may display an idle indication 38. The idle indication 38 may be, for example only, a grayscale or unlit graphic. Additionally or alternatively, the idle indication 38 may include any visual, audible, or other indicator.

In an embodiment, the state of the social media context application and/or other information may be displayed in one or more tabs 40 maintained by the application. A tab 40 may be, for example, superimposed over the interface of the web browser 28. Additionally or alternatively, a tab 40 may be displayed on a toolbar of the interface of the web browser 28, or otherwise integrated into the interface of the web browser 28. For example, a tab 40 maintained by the application may be displayed next to a tab 40 maintained by the webpage. Further, a tab 40 associated with the social media context application may be displayed constantly, or may be minimized or otherwise altered according to the state of the application, the passage of time, and/or other factors.

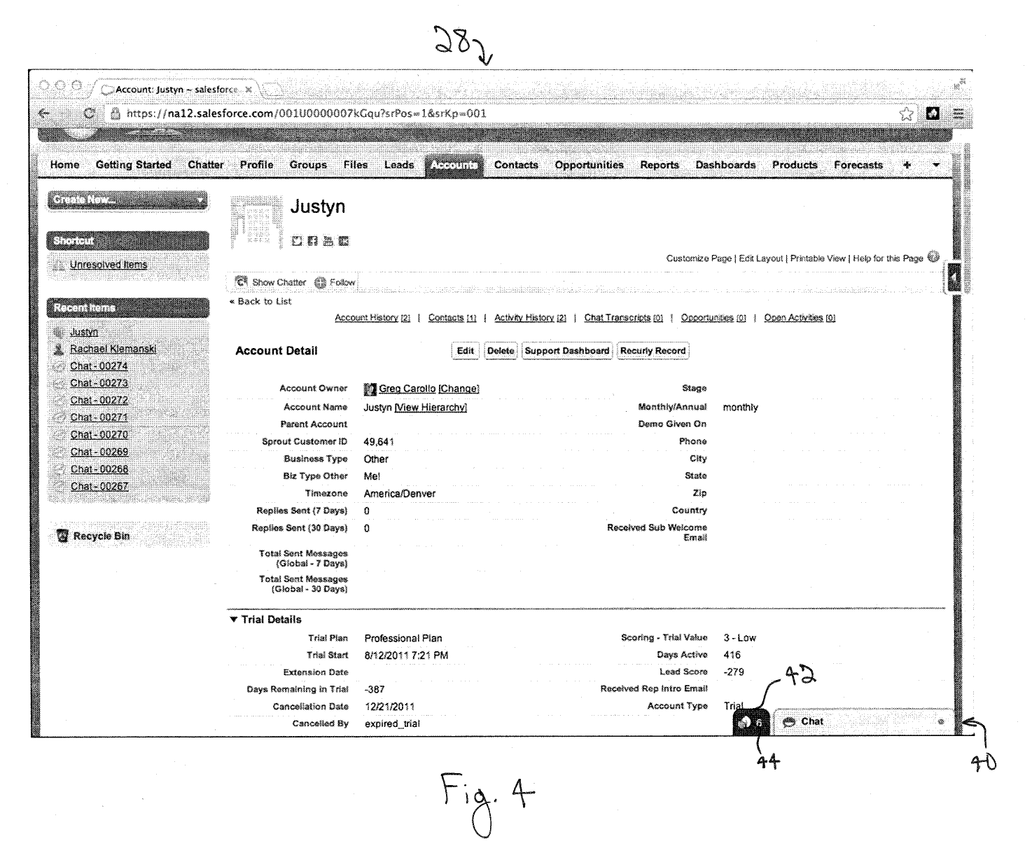

FIG. 4 illustrates the social media context application in an active state. The application may enter an active state upon determining that one or more recognized individuals or other entities are found and/or upon determining that finding one or more recognized individuals or other entities is likely. As noted above, the application may determine that an individual or other entity is recognized by identifying one or more names, email addresses, social media network usernames, URLs, or other information and comparing identified information to stored information. The application may display an active state indicator 42, in an embodiment. The active state indicator 42 may include a bolded or colored version of the same graphic used for the idle indication 38, in an embodiment. The active state indicator 42 may additionally or alternatively include any visual, audible, or other indicator.

The social media context application may provide an indication 44 of the number of interactions between the user and one or more other users of one or more social networks or other accounts, in an embodiment. The indication 44 may include the number of recognized individuals or other entities that have been found, the number of the user's accounts for which interactions have been found, the total number of interactions that have been found, etc. In an embodiment, the indication 44 of number of interactions may be included in the active state indicator 42. Additionally or alternatively, the indication 44 of number of interactions may be included elsewhere in the interface for the application.

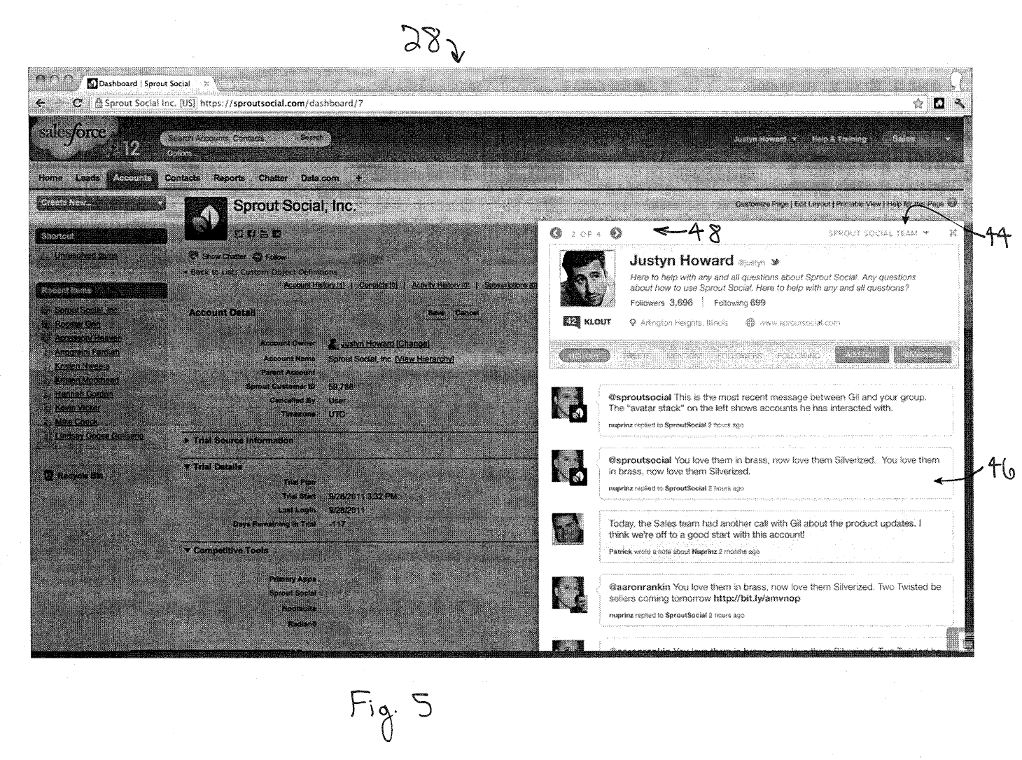

In addition to or instead of a tab 40, the social media context application may display an interface listing interactions between a user of the application and an individual or other entity recognized by the application, or an entity with which the recognized individual or other entity is associated. For example, as shown in FIG. 5, a window 44 may be displayed that includes a number of social media interactions 46 between the user of the application (in the illustrated embodiment, “Sprout Social”) and an individual recognized by the application (in the illustrated embodiment, “Justyn Howard”). The application may provide the ability for the user to toggle between the window showing interactions (shown in FIG. 5) and another interface, such as the tabs 40 (shown in FIG. 4). For example, selecting a tab 40 may open a window 44, in an embodiment.

The interactions 46 shown by the social media context application may be sorted according to the social media network or other source from which the interactions were derived, in an embodiment. For example, as illustrated in FIG. 5, interactions 46 from a single social media network may be provided in a single list, and interactions from other social media networks and other sources (e.g., other email addresses and accounts) may be accessed by the user by accessing an alternate portion of the application interface. Such alternate portions may be provided, for example, in alternate pages that can be accessed by the user. In the example of FIG. 5, the user is accessing page two (2) of four (4), as shown in the top portion 48 of the application interface. Thus, application interface illustrated in FIG. 5 is indicating that the application has records of interactions between the user and the recognized individual on four social media networks. In the illustrated exemplary embodiment, arrows in the top portion 48 of the application interface may be used to navigate between alternate pages.

The application may provide numerous pieces of information about a recognized individual or other entity, the user, and/or interactions between the two. For example, the application may display an interaction history between the user and the recognized individual or other entity, which may include direct messages between the user and recognized individual or other entity, photographs associated with the user and the recognized individual or other entity, etc. The application may additionally provide information about the characteristics of the recognized individual or other entity and/or or activity on one or more social networks or other accounts, such as, but not limited to, tweets, mentions, a list of followers, and a list of whom the recognized individual is following.

In addition to providing information about previous interactions between a user and others on social media networks, the social media context application may enable the user to communicate with others. For example, the application may include functionality for messaging a recognized individual or for more broadly sharing information with other social media users.

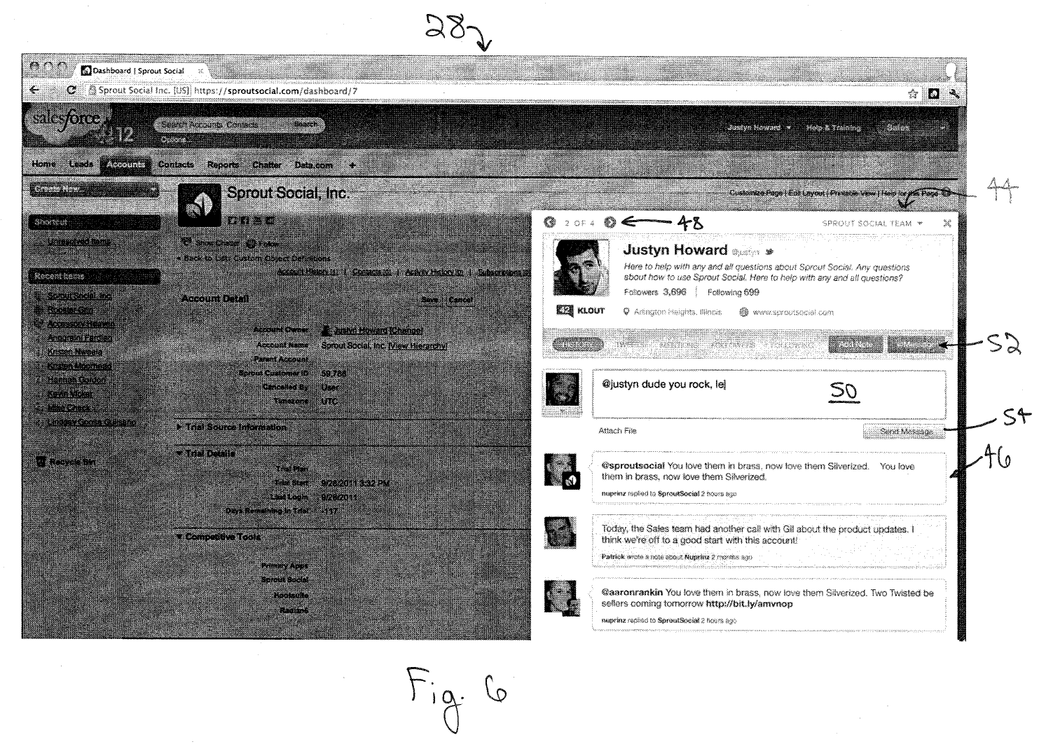

FIG. 6 illustrates a messaging function that may be provided by the social media context application. The application interface may include a text entry portion 50, the function of which may be determined according to some other input. For example, in the embodiment illustrated, the user may send a message to the recognized individual by selecting the “@Message” input 52, typing a message in the text entry portion, and selecting the “Send Message” input 54. The application may send the message within one or more of the social networks in which the user and recognized individual have interactions, in an embodiment, and/or within an independent messaging system associated only with the application.

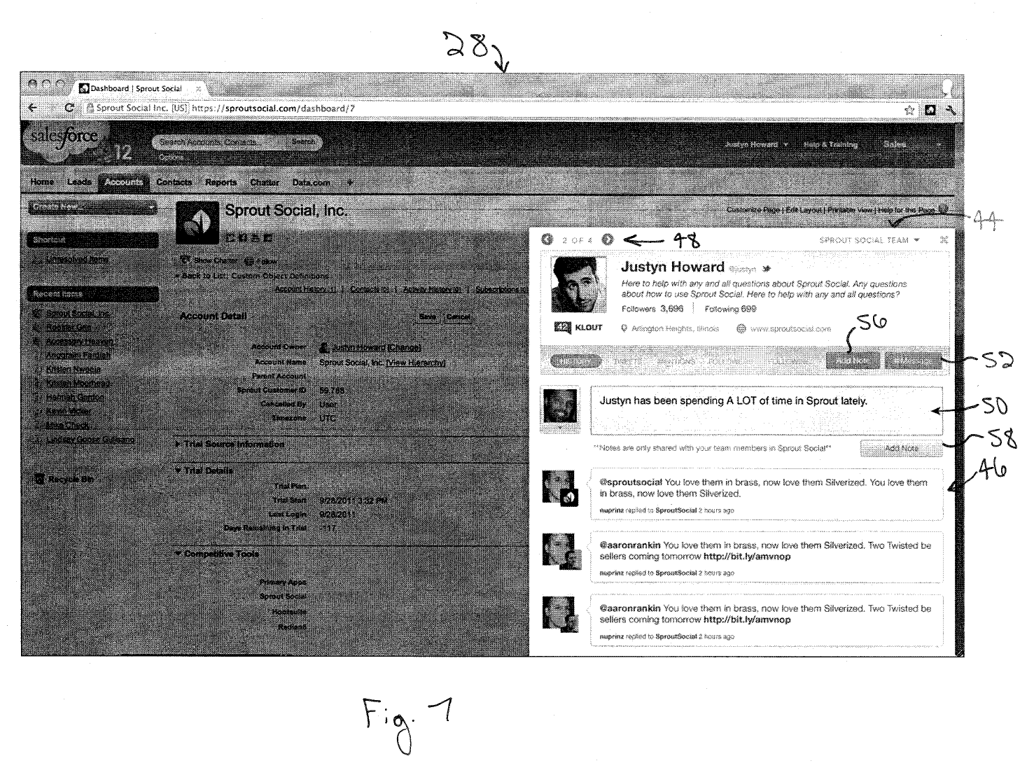

FIG. 7 illustrates a broader information sharing function that may be provided by the social media context application. The application may enable a user to form and join groups within a network associated with the application to share information. Thus, the application may itself be associated with a social media network. The user may share notes and other information with other users in groups through the application. For example, the user may select a first “Add Note” input 56, type a note into the text entry portion 50, and select a second “Add Note” input 58 to share a note with other users in a group. Furthermore, the application may provider the ability for a user to quickly switch between groups through a group selection input in the application interface.

Although described with particular reference to an embodiment in which interactions between a user and other individuals is over one or more social media networks, this disclosure is not limited to collection, storage, or provision of information about social media network interactions. Rather, the instant disclosure contemplates collection, storage, and provision of information about a broad array of electronic interactions between parties, including social media interactions, email exchanges, and the like. Accordingly, descriptions of a “social media context application” and a “social media interactions database” in this disclosure are for ease of reference only, and should not be understood so as to limit the functionality of the application or database to social media interactions.

In addition to the structures of the system 10, another aspect of the present disclosure involves the methodologies of the system 10 (particularly the methodologies of the social media context application 24). The methodologies and constituent steps thereof that may be performed and carried out by the system 10, which were described in great detail above, apply to this aspect of the disclosure with equal force. Therefore, the description of the methodologies as set forth above with respect to the system will not be repeated in full.

Although a number of embodiments have been described above with a certain degree of particularity, those skilled in the art could make numerous alterations to the disclosed embodiments without departing from the sprit or scope of this disclosure. For example, all joinder referenced (e.g., attached, coupled, connected, and the like) are to be construed broadly and may include intermediate members between a connection of elements and relative movement between elements. As such, joined references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Any patent, publication, or other disclosure material, in whole or in part, that is said to be incorporated by referenced herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system comprising:
a database configured to store instances of electronic interaction among a plurality of users; and
an application configured to be installed on a computer system of a first one of the plurality of users, the application configured to:
collect information from a website displayed in a web browser on the user computer system;
determine if the information includes a second one of the plurality of users; and
display on the user computer system one or more instances of electronic interaction between the first user and the second user that are stored in the database.

2. The system of claim 1, wherein the instances of electronic interaction comprise instances of interaction over one or more social media networks.

3. The system of claim 2, wherein the instances of electronic interaction further comprise one or more emails.

4. The system of claim 1, wherein the application is an extension of the web browser.

5. The system of claim 1, wherein the application is configured to identify each user of the plurality of users included in the information.

6. The system of claim 5, wherein the application is configured to display on the user's computer system one or more instances of interaction between the first user and each of the identified users.

7. The system of claim 1, wherein the application is further configured to determine a larger entity with which the second user is associated and to display on the user computer system one or more instances of electronic interaction between the first user and the larger entity other than the one or more instances of electronic interaction between the first user and the second user.

8. The system of claim 1, wherein the application is further configured to determine a larger entity with which the first user is associated and to display on the user computer system one or more instances of electronic interaction between the second user and the larger entity other than the one or more instances of electronic interaction between the first user and the second user.

9. A method comprising:
collecting information from a website interface displayed in a web browser of a first user's computer system;
determining if the collected information includes identification of a second user having one or more electronic interactions with the first user;
retrieving the one or more interactions from a database that stores a plurality of electronic interactions between the first user and a plurality of other users, the second user being one of the plurality of other users; and
displaying the one or more interactions over the website interface.

10. The method of claim 9, wherein the one or more electronic interactions comprise instances of interaction over one or more social media networks.

11. The method of claim 10, wherein the one or more electronic interactions comprise one or more emails.

12. The method of claim 9, wherein displaying the one or more interactions over the website interface is performed by an extension of the web browser.

13. The method of claim 9, further comprising identifying each user of the plurality of users included in the information.

14. The method of claim 13, further comprising displaying on the user's computer system one or more instances of interaction between the first user and each of the identified users.

15. The method of claim 9, further comprising determining a larger entity with which the second user is associated, and retrieving and displaying on the user computer system one or more instances of electronic interaction between the first user and the larger entity other than the one or more instances of electronic interaction between the first user and the second user.

16. The method of claim 9, further comprising determining a larger entity with which the first user is associated, and retrieving and displaying on the user computer system one or more instances of electronic interaction between the second user and the larger entity other than the one or more instances of electronic interaction between the first user and the second user.

17. A system comprising:
a database configured to store instances of electronic interaction between a first user and a plurality of other users of two or more social media networks; and
an application configured to be installed on or receive data from a computer system of the first user, the application configured to:
collect information from a website displayed in a web browser on the first user's computer system;
identify at least one of the plurality of other users in the information; and
display on the user computer system one or more instances of electronic interaction that are stored in the database between the first user and the at least one identified user.

18. The system of claim 17, wherein the instances of electronic interaction stored in the database comprise messages exchanged on the two or more social media networks and emails.

19. The system of claim 17, wherein the application is further configured to add information to the database based on the first user's activity in the web browser on one of the two or more social media networks.

20. The system of claim 17, wherein the application is configured to display the one or more instances of electronic interaction by overlaying the one or more instances of electronic interaction on the web browser.
